(19) United States
(12) Patent Application Publication
(10) Pub. No.: US 2014/0359405 A1
(43) Pub. Date: Dec. 4, 2014

(54) METHOD AND DEVICE OF DISPLAYING IMAGES IN TEXT INFORMATION

(71) Applicant: Tencent Technology (Shenzhen) Company Limited, Shenzhen (CN)

(72) Inventor: Yuejiao HOU, Shenzhen (CN)

(73) Assignee: Tencent Technology (Shenzhen) Company Limited, Shenzhen (CN)

(21) Appl. No.: 14/164,068

(22) Filed: Jan. 24, 2014

Related U.S. Application Data
(63) Continuation of application No. PCT/CN2013/088965, filed on Dec. 10, 2013.

(30) Foreign Application Priority Data
May 28, 2013 (CN) 201310204225.4

(51) Int. Cl. G06F 17/22; G06F 3/0484

(52) U.S. Cl. CPC G06F 17/2247; G06F 3/04842; G06F 3/04845
USPC 715/202

(57) ABSTRACT

Method and device of displaying images in a web interface are disclosed. The method includes: receiving page data for rendering visual content in the web interface from a server; in accordance with a determination that the respective file size of the first image is larger than a first threshold value, proactively preventing a complete download of the first image for an initial rendering of the visual content in the web interface; displaying a respective image indicator in lieu of the first image, along with the respective visual context of the first image in the web interface; in response to detecting a user input selecting the respective image indicator in the web interface, downloading the first image from the server; and replacing the respective image indicator with the downloaded first image in the web interface.

### RELATED APPLICATIONS

This application is a continuation application of PCT Patent Application No. PCT/CN2013/088965, entitled “METHOD AND DEVICE OF DISPLAYING IMAGES IN TEXT INFORMATION” filed Dec. 10, 2013, which claims priority to Chinese Patent Application No. 201310204225.4, “METHOD AND DEVICE OF DISPLAYING IMAGES IN TEXT INFORMATION” filed May 28, 2013, both of which are hereby incorporated by reference in their entirety.

### FIELD OF THE INVENTION

The present disclosure relates to the Internet field, and especially relates to a method and device of displaying images in text information.

### BACKGROUND OF THE INVENTION

With the continuous development and popularization of mobile terminals, users have increasingly higher requirements on the adaptability of mobile terminals.

For example, with conventional technology, a user may often encounter large images when the user browses a webpage via a mobile phone. Under the circumstance of a limited data plan, the mobile phone may be configured by the user into an image-free mode in which images are not downloaded and displayed to save data usage.

The above mentioned method of manually hiding all images via a setting interface has the disadvantage of burdensome operation. A user needs to close the image-free mode in the settings interface, and to view the image by refreshing the entire page. Meanwhile, after closing the image-free mode, all the hidden images are downloaded and displayed, which consume a lot of data quota. Also, the image-free mode turns on and off image downloading for the entire browser regardless of the content of the webpage.

There is a need for a more nuanced and targeted method of choosing which images to download and display. Preferably, such method does not add to the complexity of operation while giving more choices to a user on whether to display a particular image.

### SUMMARY

In some embodiments, a method of displaying images in a web interface is performed at a device (e.g., a mobile device) having one or more processors and memory storing instructions for execution by the one or more processors. The method includes: receiving page data for rendering visual content in the web interface from a server, the page data including a respective identification of a first image and a respective visual context of the first image, and the respective identification of the image including a respective file size of the first image; in accordance with a determination that the respective file size of the first image is larger than a first threshold value, proactively preventing a complete download of the first image for an initial rendering of the visual content in the web interface; displaying a respective image indicator in lieu of the first image, along with the respective visual context of the first image in the web interface; in response to detecting a user input selecting the respective image indicator in the web interface, downloading the first image from the server; and replacing the respective image indicator with the downloaded first image in the web interface.

In another aspect, a device comprises one or more processors, memory, and one or more program modules stored in the memory and configured for execution by the one or more processors. The one or more program modules including instructions for performing the method described above. In another aspect, a non-transitory computer readable storage medium having stored thereon instructions, which, when executed by a device, cause the device to perform the method described above.

Various other aspects and advantages of the invention are apparent in light of the descriptions below.

### BRIEF DESCRIPTION OF THE DRAWINGS

The aforementioned features and advantages as well as additional features and advantages thereof will be more clearly understood hereinafter as a result of a detailed description of preferred embodiments when taken in conjunction with the drawings.

FIG. 1 is a flowchart of an image displaying method in accordance with some embodiments;

FIG. 2a and FIG. 2b are webpages displayed by a device in accordance with some embodiments;

FIG. 3 is a flowchart of an image displaying method in accordance with some embodiments;

FIG. 4 is a schematic structural diagram of an image displaying device in accordance with some embodiments;

FIG. 5 is a flowchart of an image displaying method in accordance with some embodiments;

FIGS. 6a and 6b are webpages displayed by a device in accordance with some embodiments; and

FIG. 7 is a schematic structural diagram of an image displaying device in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

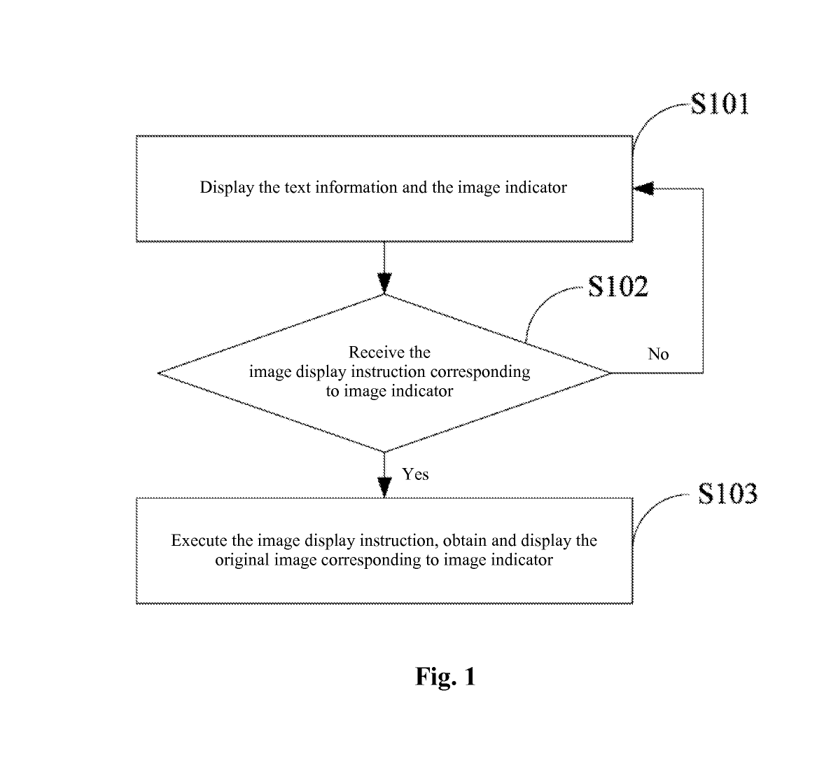

FIG. 1 is a flowchart of displaying images in a web interface in accordance with some embodiments.

In step S101, a device displays text information and an image indicator.

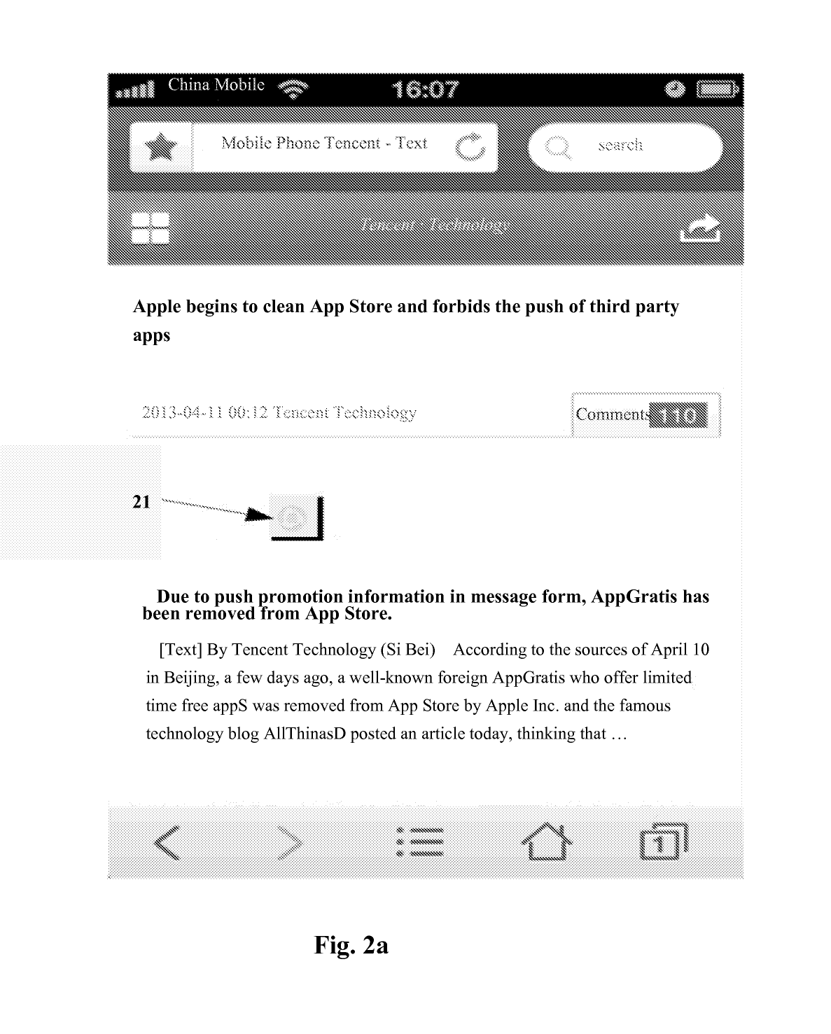

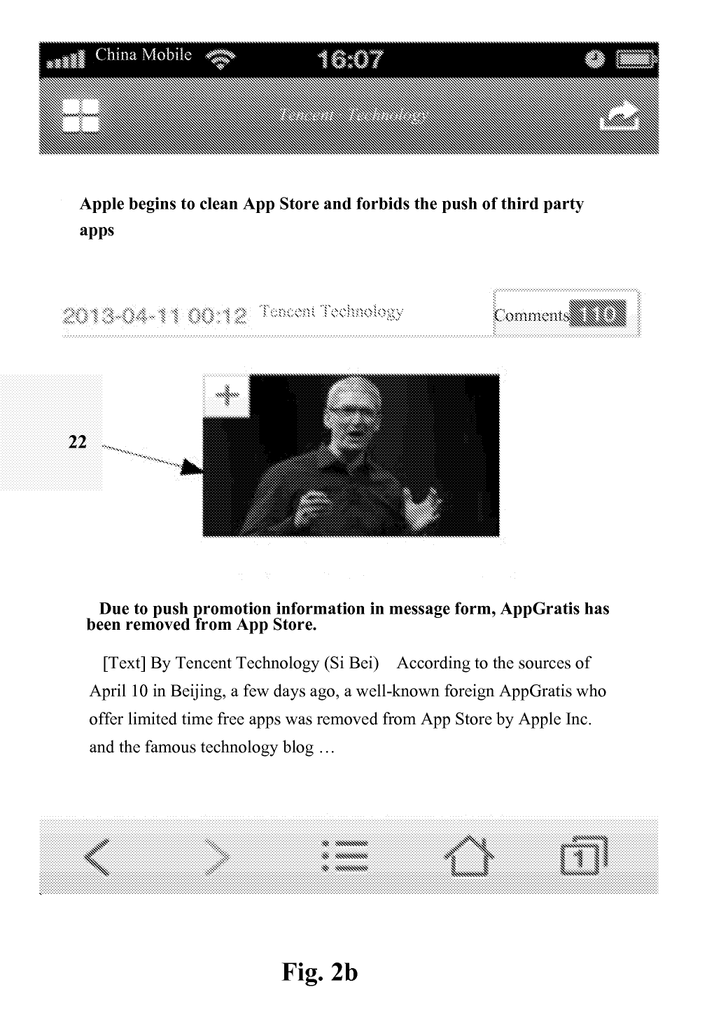

In some embodiments, an image indicator is associated with an original image. In some embodiments, the image indicator is in a round button shape. FIG. 2a shows a schematic diagram of an image indicator when a browser on a mobile phone is displaying webpage text information. In FIG. 2a, the image indicator 21 is in a square button shape. In some embodiments, the image indicator 21 is in other shapes and appearances. In some embodiments, the image indicator occupies a small area and has a small data size to reduce the Internet data usage of the mobile terminal browsing the Internet. For example, in FIG. 2a, the image indicator has a first display area with a size M1 and text in the webpage has a second display area with a size M2, and M1≦M2. In some embodiments, M1, the size of the first display area, can be larger than M2, the size of the second display area.

In step S102, the device determines whether an image display instruction corresponding to the image indicator has been received. If yes, the device proceeds to step S103. Otherwise, the device proceeds to step S101.

In some embodiments, when browsing webpage information on a touch screen mobile device (e.g., a touch screen smartphone or a touch screen tablet device), the user can select the image indicator on the webpage via a touch input. Once the touch screen mobile device detects that the image indicator is selected, it determines that an image display instruction is received. Alternatively, in some embodiments, when browsing a webpage (e.g., the Tencent Weibo) on a computer (e.g., a portable computer), a user can click the image indicator in the webpage (e.g., Weibo information) by a mouse. Once the computer detects that the image indicator in the webpage is selected, the computer determines that an image display instruction is received.

In step S103, the device executes the image display instruction, obtains and displays the original image corresponding to the image indicator.

In some embodiments, each image on a webpage can be given a respective image indicator. In some embodiments, some images in a webpage may be selectively given respective image indicators, while other images in the same webpage are not given respective image indicators. In some embodiments, the image indicators are linked to original images. When the device receives the image display instruction via a selection of an image indicator, it obtains the original image linked to the image indicator. In some embodiments, the device firstly determines if there is any original image in the text information. If yes, the device hides the original image (e.g., prevents the complete download and display of the original image) and uses the image indicator to replace the original image to indicate the existence of original image in the displayed webpage. In some embodiments, there is a link from the image indicator to the original image. When the device receives the image display instruction via selection of a particular image indicator, it obtains the corresponding original image via the link (e.g., the URL of the original image).

For example, as shown in FIGS. 2a and 2b, after the user has selected the image indicator 21 in FIG. 2a, the device obtains the original image (e.g., original image 22) corresponding to the image indicator 21, and displays the original image 22 in FIG. 2b.

In some embodiments, an image indicator occupies a smaller display area than the original image. These embodiments not only save data usage, but also enhance user experience by ensuring the aesthetics of the entire text information. In some embodiments, an image indicator occupies the same display area and position as the original image in the webpage. Such embodiments allows saving data usage, while providing the user with the proper visual context of the original images.

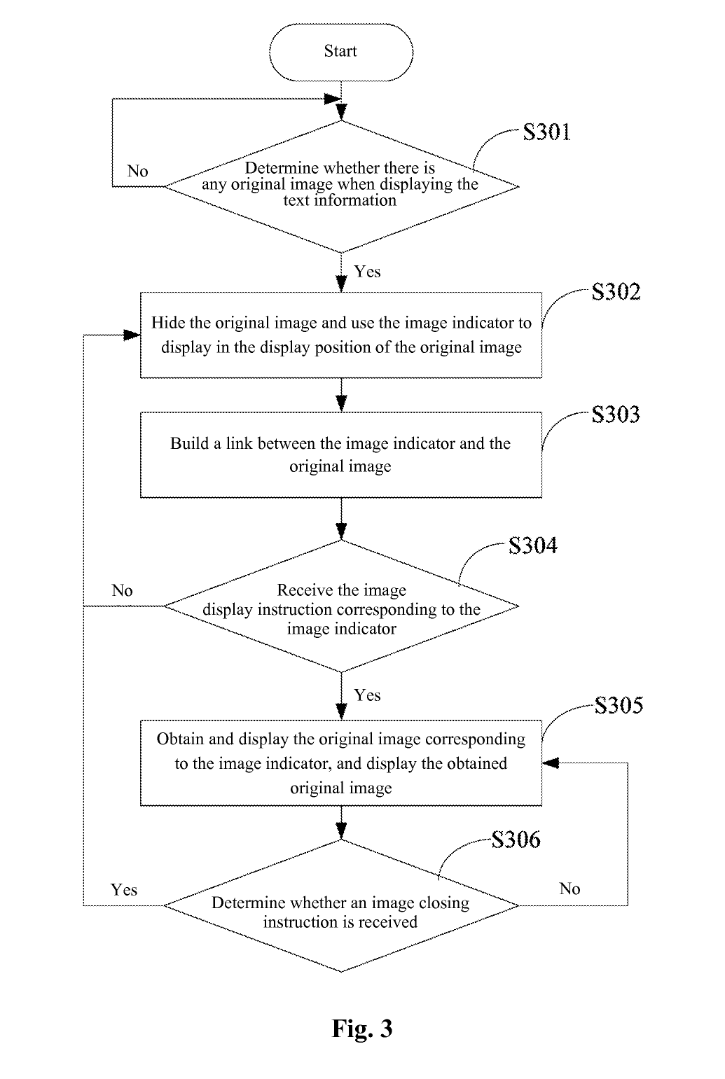

FIG. 3 is a schematic flow diagram of an image display method in accordance with some embodiments.

In step S301, the device determines whether there is any original image to be displayed among the text information in the webpage (e.g., the textual portion of the webpage). If yes, the device proceeds to step S302. Otherwise, the device proceeds to step S301.

In some embodiments, when displaying the text information, the device determines whether there is any original image in the text information. For example, in displaying the Tencent Weibo webpage, a mobile phone determines whether there is any original image present along the text information of the Weibo webpage.

In step S302, the device hides the original image (e.g., prevents complete download and display of the original image) and uses the image indicator to replace the original image in the same display position in the webpage.

For example, once the device identifies an original image in the webpage, the device sets an image indicator in the position of the original image, and builds a link between the image indicator and the original image. When the device receives the image display instruction, it obtains the original image linked to image indicator and displays it in the current window. It is noted that once the device identifies that there is an original image in the webpage (e.g., through the embedded hyperlink to the original image in the source code of the webpage, or the instructions in the script for downloading the original image), the device optionally determines a size of the original image before determining whether to proceed with the actual download of the original image. If the device determines that the original image is to be hidden in the webpage, the device stops the downloading process for retrieving the original image if it has already been initiated, or prevents the downloading process for retrieving the original image from being started at all.

In step S303, the device builds a link between the image indicator and the original image.

In step S304, the device determines whether the image display instruction corresponding to the image indicator is received. If yes, the device proceeds to step S305. Otherwise, the device proceeds to step S304.

In step S305, the device obtains and displays the original image corresponding to the image indicator.

The original image corresponding to the image indicator is the original image that is linked with the image indicator as mentioned in step S303.

In step S306, the device determines whether an image closing instruction is received. If yes, the device proceeds to step S302. Otherwise, the device proceeds to step S305.

In some embodiments, in order to determine whether the image closing instruction is received, the device determines whether a click at other places of the webpage is received. If yes, it determines that it has received the image closing instruction. In some embodiments, in order to determine whether the image closing instruction is received, the device determines whether a click on the original image is received. If yes, the device determines that the image closing instruction has been received. Of course, the device can determine whether the image closing instruction is received via other ways, e.g., determining whether a predetermined image closing gesture input has been received, or if a dedicated hot key (or key combination) for closing the image has been pressed.

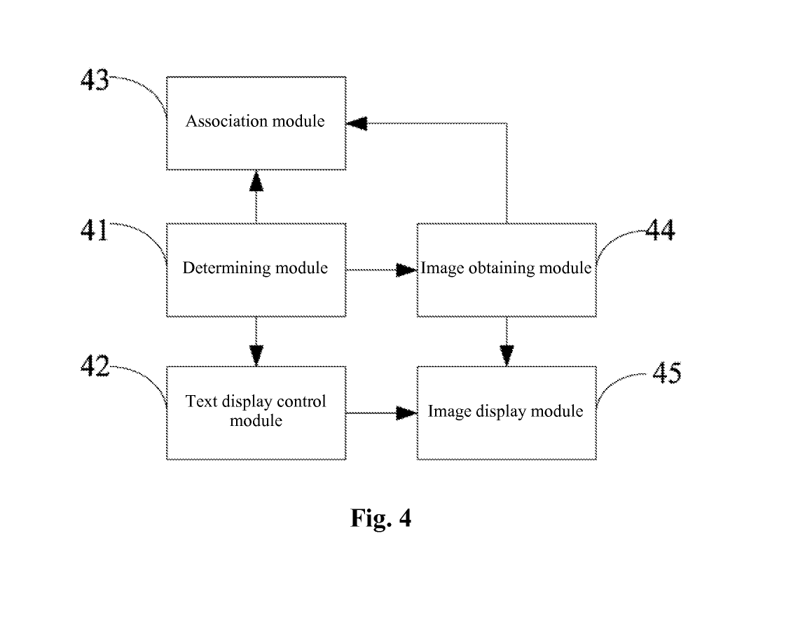

FIG. 4 is a schematic diagram of the structure of a device of displaying images in text information in accordance with some embodiments. The device includes a determining module 41, a text display control module 42, an association module 43, an image obtaining module 44 and an image display module 45.

When displaying the text information in a webpage, the determining module 41 determines whether there is any original image to be displayed with the text information in the webpage. If the determining module 41 determines that there is an original image to be with the text information in the webpage, the text display control module 42 hides (e.g., prevents complete download and display of) the original image and displays an image indicator in the position of the original image in the webpage. The association module 43 builds a link between the image indicator and the original image.

When the text display control module 42 is displaying the text information and the image indicator in the webpage, the determining module 41 determines whether an image display instruction corresponding to the image indicator is received from a user. If the determining module 41 determines that it receives the image display instruction corresponding to the image indicator, the image obtaining module 44 obtains the original image corresponding to the image indicator and the image display module 45 displays the original image obtained by the image obtaining module 44.

In the process of the image display module 45 displaying the original image obtained by the image obtaining module 44, the determining module 41 also determines whether the image closing instruction is received from the user. If the determining module 41 determines that it has received the image closing instruction, then the text display control module 42 hides the original image (e.g., ceases to display the original image in the webpage) and displays the image indicator in the position of the original image.

In some embodiments, in order to determine whether the image closing instruction is received, the determining module 41 determines whether a click directed to the original image or texts is received; if yes, it determines that it has received the image closing instruction.

In some embodiments, if the image indicator has a first display area with a size M1 and the text in the webpage has a second display area with a size M2, then M1≦M2.

In some embodiments, an image indicator occupies a smaller area than the original image. These embodiments not only save data usage, but also enhance user experience by ensuring the aesthetics of the entire text information.

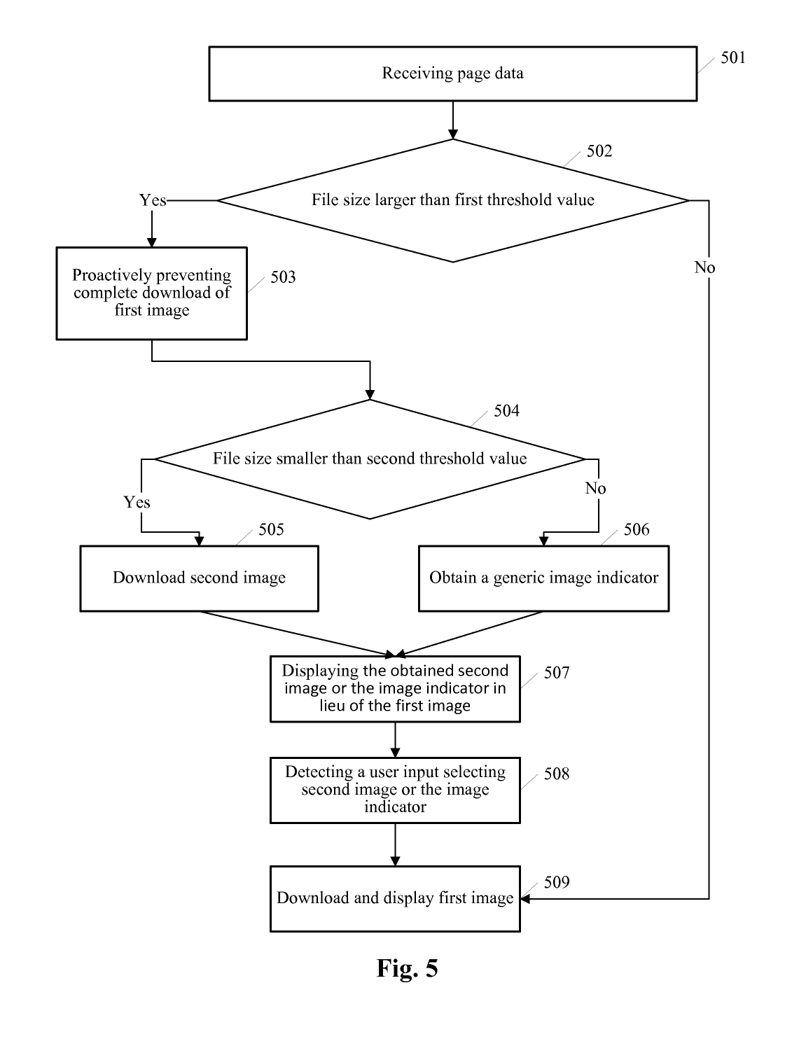

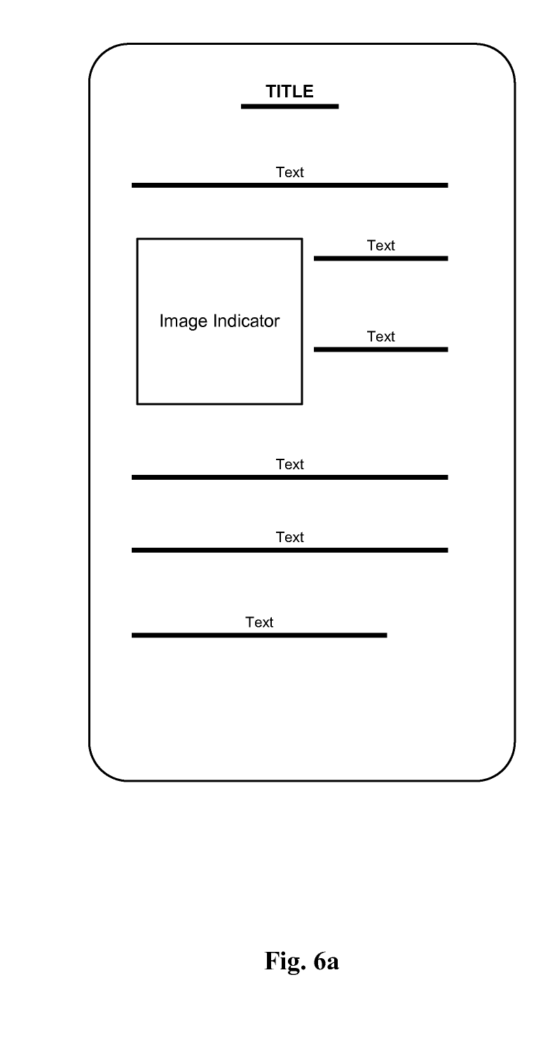

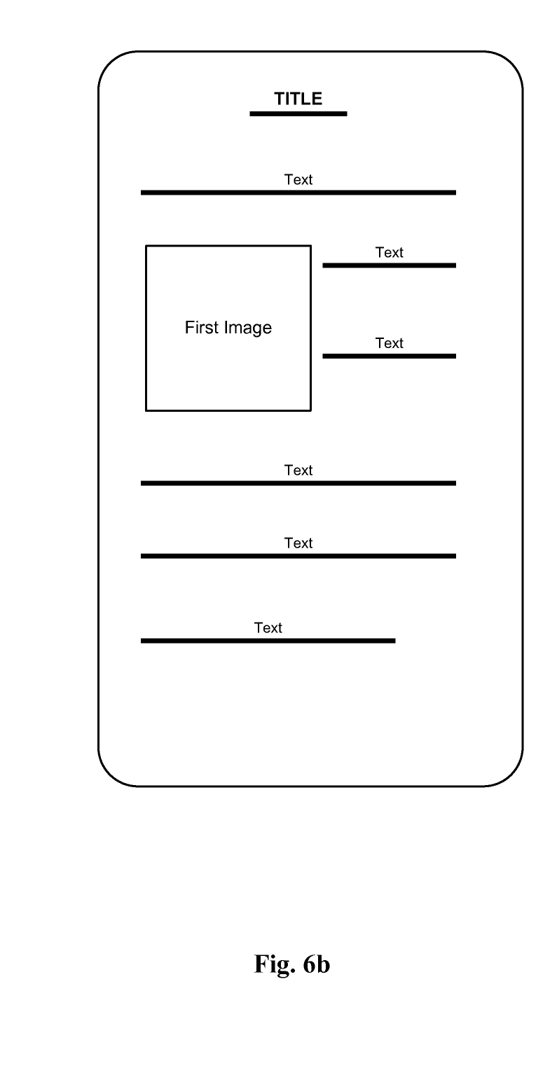

FIG. 5 is a flowchart of displaying images in a web interface in accordance with some embodiments. The method is performed at a device having one or more processors and memory storing instructions for execution by the one or more processors. FIGS. 6a and 6b show an image indicator of a first image and the first image respectively displayed in a webpage with the method illustrated in FIG. 5, in accordance with some embodiments.

In step 501, the device receives page data for rendering visual content in the web interface from a server. In some embodiments, the page data includes a respective identification of a first image and a respective visual context of the first image. In some embodiments, the respective identification of the image specifies a respective file size of the first image. In this specification, a file size of an image means the data size (e.g., in terms of pixel counts, or display resolution and display size) of the image file.

In some embodiments, the page data includes the HTML source code for the displayed webpage, the WAP source code for the displayed webpage, and/or data in other format that supplies the content and structure of a webpage or other visual content to be rendered in the web interface.

In some embodiments, the identification of the first image includes attributes of the first image, including some or all of the alignment, height, width, link, border and the file size of the first image. In some embodiments, the identification of the first image is received as an image tag which is part of the source code of the webpage. For example, a person skilled in the art can expand the image tag information of the HTML code or WAP code to include the file size of the first image along with other attributes of the first image.

In some embodiments, if the original page data does not include the file size of the first image, the device sends a request (e.g., an HTTP request) to the server and read the files size information (e.g., the Content-Length header) of the image file. The file size information of the image file is then stored as additional page data. In the typical structure of HTML code and WAP code, each image is provided with a separate link from which the image is to be downloaded from the server. The design of providing separate link for each image facilitates acquiring the file size of each image rather than the whole webpage. In some embodiments, the device and the server communicates with a protocol, according to which, the identifications of images are provided first and the images can be downloaded upon the requests of the device. For example, an application for a smart phone can have a unique image display protocol between a server and a device. In some embodiments, the original page data specifies a script that is to be executed on a web server, and the execution of the script causes the original image to be downloaded to the client device. In some embodiments, the client device determines from the script that an image exists in the webpage, and requests the server to send image size information before requesting the server to execute the script.

In some embodiments, the visual context of the first image includes text information of the webpage. For example, in a webpage, the visual context of the first image include other visual content such as text blocks, frames, headings, embedded media player objects, etc, that are laid out according to the specification of the source code of the webpage, and optionally, in conjunction with the browser's default settings for rendering webpages.

In step 502, the device determines whether the respective file size of the first image is larger than a first threshold value. If the respective file size of the first image is not larger than the first threshold value, the device downloads and displays the first image along with the visual context of the first image as in step 509 in accordance with some embodiments. For example, if the first threshold is 300 MB in size, and the first image is of a size less than 300 MB, then, the device downloads and displays the first image along with other visual context (e.g., surrounding text and objects) of the first image in the webpage. Note that, in some embodiments, the above determination is made on an image by image basis, and the visual context of the first image does not include other images in the webpage.

In step 503, in accordance with a determination that the respective file size of the first image is larger than a first threshold value, the device proactively prevents a complete download of the first image for an initial rendering of the visual content in the web interface. For example, if the first threshold value is 300 MB, and the first image is of a size greater than 300 MB, the device terminates the downloading of the first image if it has already started, or prevents the downloading process of the first image from starting at all.

In some embodiments, when each image is separately associated with respective URLs (e.g., when the webpage is written in HTML), the device prevents any downloading from the link of the first image until it has determined that the files size of the first image is no larger than the first threshold value. In some embodiments, the visual context information is automatically downloaded, and the link of the image is visited for downloading only after the device has initiated the downloading after determining the file sizes of images.

In step 504, the device determines whether the respective file size of the first image is smaller than a second threshold value. In some embodiments, the second threshold value is larger than the first threshold value. In step 505, in some embodiments, in accordance with a determination that the respective file size of the first image is smaller than a second threshold value, the device requests the server to send a second image that is a low resolution version of the first image. After receiving the second image from the server, the device uses the second image as the respective image indicator of the first image.

In this specification, the first and second threshold values are both specific file sizes. For example, the first threshold value is 300 MB, and the second threshold value is 500 MB in some embodiments. In some embodiments, the first and/or second threshold values are set by a user of the device. In some embodiments, the device stores a plurality of image size policies for adjusting and changing the first and second threshold values. In some embodiments, a user sets a monthly data plan which specifies the desired upper limit of downloading data (e.g., a download quota in terms of total bytes) in the month. In some embodiments, an image size policy dynamically changes the first and/or the second threshold value according to a data plan setting by calculating previous downloading data usage and days left in this month. If there is much downloading quota left unused near the end of a month, the image size policy increases the first and/or second threshold values. If there is little downloading quota left unused at the early days of a month, the image size policy decreases the first and/or second threshold values. In some embodiments, an image size policy is related with the total sizes of all images in a webpage, if there are lots of images in one webpage and/or the total file size of all the images is huge, the image size policy decreases the first and/or second threshold values for each image.

In some embodiments, the device determines one or more suitable image size policies from a plurality of image size policies for preventing the display of the first image in the initial rendering of the visual content. Two or more policies may be applied together, where any one of the policies may prevent the complete download and display of the first image. For example, if according to one policy, the first image may be downloaded, but according to another policy, the first image should not be downloaded, then the device does not download the first image.

In some embodiments, the server creates a low resolution version of the first image after receiving the request from the device. In some embodiments, the request of the device for the second image includes a specific file size requirement. For example, the device requests the server to send a second image that is smaller than 50 kb. The file size requirement can be determined by image size policies as well. A person skilled in the art would recognize there are quite a few methods available to reduce the resolution of an image.

In some embodiments, the server produces low resolution versions for some or all images that are displayed with the webpage before receiving any requests for the lower resolution images. After receiving the request for the second image, the server sends the low resolution version of the first image to the device. In some embodiments, the server sends a respective identification of the second image to the device. In some embodiments, the device then executes steps 501-502 again. If the second image is still larger than the first threshold, the device then executes step 506 to obtain a generic image identifier (this is not shown in FIG. 5).

In some embodiments, in accordance with a determination that the respective file size of the first image is greater than the second threshold value, the device executes step 506. In step 506, in some embodiments, the device obtains a generic image indicator from a local storage device and uses the generic image indicator as the respective image indicator of the first image.

In some embodiments, the generic image indicator is an image that is indicative of reason that has prevented the downloading and displaying of the first image in the initial rendering of the webpage, e.g., the file size of the first image being larger than the first threshold value, or the particular image display policy that was triggered. In some embodiments, the local storage device has a plurality of image indicators, each representing a respective reason that an original image is not downloaded and displayed. For example, one image indicator may be indicative of an advertisement image. In some embodiments, each of the plurality of image size policies is associated with a respective unique image indicator stored locally at the device. When an image size policy prevents the display of the first image, the device obtains and displays a respective generic image indicator that is associated with policy.

In step 507, in some embodiments, the device displays a respective image indicator or the second image (depending on which one is used) in lieu of the first image, along with the respective visual context of the first image in the web interface as shown in FIG. 6a. In some embodiments, the height, width and position relative to the visual context of the image indicator is the same with that of the first image (which can be obtained from the identification of the first image). In some embodiments, the size of the image indicator is smaller than the first image. In some embodiments, the width and height of the image indicator is adjusted according to the structure of the webpage and the width and height of the screen.

In some embodiments, the device generates the respective image indicator by adding a colored frame to a generic image indicator (or a second image), wherein a respective color of the colored frame is selected in accordance with the file size of the first image. For example, a blue frame indicates that the first image is from 10 KB to 100 KB, a yellow frame indicates that the first image is from 100 KB to 1 MB, and a red frame indicates that the first image has a size exceeding 1 MB.

In some embodiments, the image indicators used to replace the original images are advertising images that dynamically retrieved from an advertising server, where the download of the advertising image is paid for by the advertisers and does not count against the user's download quota. For example, when the original image in the webpage is too large, and an image indicator is needed to replace the first image in the initial rendering of the webpage, the device sends a request to the advertising server, specifying a size and format requirement for the image indicator, and the advertising server will sends an appropriate advertising image to the device, and reimburse the user's account for the download quota that was used for the downloading of the advertising image. In some embodiments, the device sends the link of the original first image to the advertising server, such that the advertising server can select a suitable advertising image based on the content of the first image. In some embodiments, an advertising image is displayed as the image indicator with a visual cue signaling to the user that an advertising image is displayed in lieu of the original image at this location.

In step 508, in some embodiments, in response to detecting a user input selecting the respective image indicator or the second image in the web interface, the device downloads the first image from the server. In some embodiments, the user input includes a touch input on a screen at the area of the image indicator or second image, a mouse clicking the image indicator or second image, voice instructions, etc.

In step 509, in some embodiments, the device downloads the first image from the server and replaces the respective image indicator or second image with the downloaded first image in the web interface as shown in FIG. 6b. In some embodiments, after replacing the second image or the image indicator with the first image, the device displays the first image in an image display mode. In an image display mode, the first image covers all or at least 90% area of a screen. The effect of the image display mode is to display one image in full screen. In some embodiments, when there are more than one image in the webpage, the user can instruct the device (e.g., touching the right side of a screen) to display the next image in the webpage. In some embodiments, the user can exit the image display mode and enter the normal mode by double click the image or touch an exit icon in the screen. In the normal mode, images are displayed among its textual context as described in their identifications. In FIG. 6b, the first image is displayed in the normal mode.

In some embodiments, the above process is performed for each image in a webpage, and the process may be performed in a serial or a parallel fashion depending on the particular configuration of the device and/or the particular configuration of the webpage.

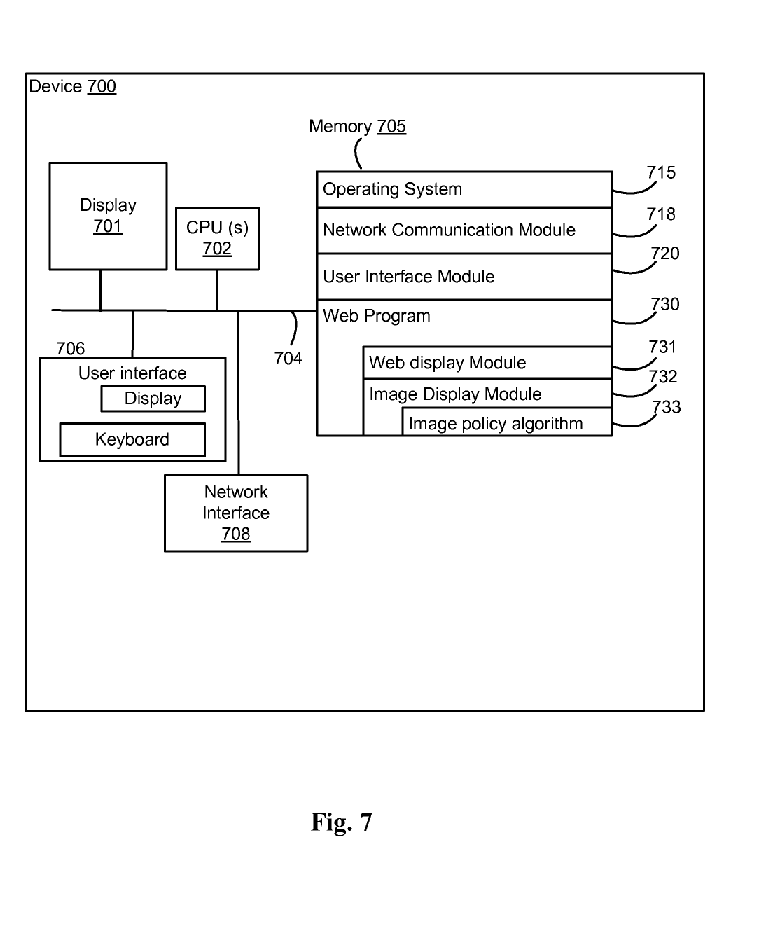

FIG. 7 is a diagram of an example implementation of an image displaying device 700 in accordance with some embodiments. In some embodiments, the device 700 includes one or more processing units (CPU's) 702, one or more network or other communications interfaces 708, a display 701, memory 705, and one or more communication buses 704 for interconnecting these and various other components. The communication buses may include circuitry (sometimes called a chipset) that interconnects and controls communications between system components. The memory 705 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 705 may optionally include one or more storage devices remotely located from the CPU(s) 702. The memory 705, including the non-volatile and volatile memory device(s) within the memory 705, comprises a non-transitory computer readable storage medium.

In some implementations, the memory 705 or the non-transitory computer readable storage medium of the memory 705 stores the following programs, modules and data structures, or a subset thereof including an operating system 715, a network communication module 718, a user interface module 720, and a web program 730.

The operating system 715 includes procedures for handling various basic system services and for performing hardware dependent tasks.

The network communication module 718 facilitates communication with other devices via the one or more communication network interfaces 708 (wired or wireless) and one or more communication networks, such as the internet, other wide area networks, local area networks, metropolitan area networks, and so on.

The user interface module 720 is configured to receive user inputs through the user interface 706.

The web program 730 is configured to download and display a webpage. The web program 730 comprises a web display module 731 and an image display module 732. The web display module 731 is configured to display a webpage according to the webpage data and instructions from the image display module. The image display module 732 is configured to determine whether to download a particular image and the way the image is displayed. The image display module 732 comprises an image policy algorithm 733. The image policy algorithm 733 is configured to determine the first and second threshold values according to user settings. The web program 730 optionally includes other modules and sub-modules for performing other operations described above with respect to various embodiments.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of displaying images in a web interface, comprising:
at a device having one or more processors and memory storing instructions for execution by the one or more processors:
receiving page data for rendering visual content in the web interface from a server, the page data including a respective identification of a first image and a respective visual context of the first image, and the respective identification of the image including a respective file size of the first image;
in accordance with a determination that the respective file size of the first image is larger than a first threshold value, proactively preventing a complete download of the first image for an initial rendering of the visual content in the web interface;
displaying a respective image indicator in lieu of the first image, along with the respective visual context of the first image in the web interface;
in response to detecting a user input selecting the respective image indicator in the web interface, downloading the first image from the server; and
replacing the respective image indicator with the downloaded first image in the web interface.

2. The method of claim 1, further comprising:
in accordance with a determination that the respective file size of the first image is larger than a first threshold value, requesting the server to send a second image that is a low resolution version of the first image;
receiving the second image from the server; and
using the second image as the respective image indicator of the first image.

3. The method of claim 1, further comprising:
determining a respective image size policy from a plurality of image size policies for preventing the display of the first image in the initial rendering of the visual content, each of the plurality of image size policies being associated with a respective unique image indicator stored locally at the device; and
selecting the respective image indicator for replacing the first image in accordance with the determined respective image size policy.

4. The method of claim 1, further comprising:
in accordance with a determination that the respective file size of the first image is smaller than a second threshold value, the second threshold value greater than the first threshold value:
requesting the server to send a second image that is a low resolution version of the first image;
receiving the second image from the server; and
using the second image as the respective image indicator of the first image; and
in accordance with a determination that the respective file size of the first image is greater than the second threshold value:
obtaining a generic image indicator from a local storage device; and
using the generic image indicator as the respective image indicator of the first image.

5. The method of claim 1, wherein displaying the respective image indicator in lieu of the first image further comprises:
generating the respective image indicator by adding a colored frame to a generic image indicator, wherein a respective color of the colored frame is selected in accordance with the file size of the first image.

6. The method of claim 1, further comprising:
dynamically changing the first threshold value according to a data plan setting.

7. The method of claim 1, further comprising:
upon detecting that the page data identifies more than one image associated with the respective visual context of the first image, dynamically changing the first threshold value according to a total file size of all images associated with the respective visual context of the first image.

8. The method of claim 1, wherein the respective identification of the first image further includes a respective height, width and position of the first image relative to the respective visual context of the first image, and wherein the respective image indicator is displayed with the respective height, width, and position of the first image in the web interface.

9. The method of claim 1, further comprising:
after replacing the second image with the first image, displaying the first image in an image display mode, wherein the first image covers at least 90% area of a graphical user interface of the device.

10. A device of displaying images in a web interface, comprising:
one or more processors; and
memory storing one or more programs for execution by the one or more processors, the one or more programs including instructions for:
receiving page data for rendering visual content in the web interface from a server, the page data including a respective identification of a first image and a respective visual context of the first image, and the respective identification of the image including a respective file size of the first image;
in accordance with a determination that the respective file size of the first image is larger than a first threshold value, proactively preventing a complete download of the first image for an initial rendering of the visual content in the web interface;
displaying a respective image indicator in lieu of the first image, along with the respective visual context of the first image in the web interface;
in response to detecting a user input selecting the respective image indicator in the web interface, downloading the first image from the server; and
replacing the respective image indicator with the downloaded first image in the web interface.

11. The device of claim 10, wherein the one or more program modules further include instructions for:
in accordance with a determination that the respective file size of the first image is larger than a first threshold value, requesting the server to send a second image that is a low resolution version of the first image;
receiving the second image from the server; and
using the second image as the respective image indicator of the first image.

12. The device of claim 10, wherein the one or more program modules further include instructions for:
determining a respective image size policy from a plurality of image size policies for preventing the display of the first image in the initial rendering of the visual content, each of the plurality of image size policies being associated with a respective unique image indicator stored locally at the device; and
selecting the respective image indicator for replacing the first image in accordance with the determined respective image size policy.

13. The device of claim 10, wherein the one or more program modules further include instructions for:
in accordance with a determination that the respective file size of the first image is smaller than a second threshold value, the second threshold value greater than the first threshold value:
requesting the server to send a second image that is a low resolution version of the first image;
receiving the second image from the server; and
using the second image as the respective image indicator of the first image; and
in accordance with a determination that the respective file size of the first image is greater than the second threshold value:
obtaining a generic image indicator from a local storage device; and
using the generic image indicator as the respective image indicator of the first image.

14. The device of claim 10, wherein displaying the respective image indicator in lieu of the first image further comprises:
generating the respective image indicator by adding a colored frame to a generic image indicator, wherein a respective color of the colored frame is selected in accordance with the file size of the first image.

15. The device of claim 10, wherein the one or more program modules further include instructions for:
dynamically changing the first threshold value according to a data plan setting.

16. The device of claim 10, wherein the one or more program modules further include instructions for:
upon detecting that the page data identifies more than one image associated with the respective visual context of the first image, dynamically changing the first threshold value according to a total file size of all images associated with the respective visual context of the first image.

17. The device of claim 10, wherein the respective identification of the first image further includes a respective height, width and position of the first image relative to the respective visual context of the first image, and wherein the respective image indicator is displayed with the respective height, width, and position of the first image in the web interface.

18. The device of claim 10, wherein the one or more program modules further include instructions for:
after replacing the second image with the first image, displaying the first image in an image display mode, wherein the first image covers at least 90% area of a graphical user interface of the device.

19. A non-transitory computer readable storage medium having instructions stored thereon, the instructions, when executed by one or more processors, cause the processors to perform operations comprising:
receiving page data for rendering visual content in the web interface from a server, the page data including a respective identification of a first image and a respective visual context of the first image, and the respective identification of the image including a respective file size of the first image;
in accordance with a determination that the respective file size of the first image is larger than a first threshold value, proactively preventing a complete download of the first image for an initial rendering of the visual content in the web interface;
displaying a respective image indicator in lieu of the first image, along with the respective visual context of the first image in the web interface;
in response to detecting a user input selecting the respective image indicator in the web interface, downloading the first image from the server; and
replacing the respective image indicator with the downloaded first image in the web interface.

20. The computer readable storage medium of claim 19, wherein the one or more programs further include instructions for:
upon detecting that the page data identifies more than one image associated with the respective visual context of the first image, dynamically changing the first threshold value according to a total file size of all images associated with the respective visual context of the first image.
